(19) United States
(12) Patent Application Publication
(10) Pub. No.: US 2026/0122610 A1
(43) Pub. Date: Apr. 30, 2026

(54) NETWORKED ECOSYSTEM WITH CENTRALIZED EXTENDED MULTI-HOP PROXIMITY RANGING

(71) Applicant: GM GLOBAL TECHNOLOGY OPERATIONS LLC, Detroit, MI (US)

(72) Inventors: Venkata Naga Siva Vikas Vemuri, Farmington Hills, MI (US); Azin Neishaboori, Plymouth, MI (US); Jinzhu Chen, Troy, MI (US); Fan Bai, Ann Arbor, MI (US); John Sergakis, Bloomfield Hills, MI (US)

(73) Assignee: GM GLOBAL TECHNOLOGY OPERATIONS LLC, Detroit, MI (US)

(21) Appl. No.: 18/931,706

(22) Filed: Oct. 30, 2024

(51) Int. Cl. H04W 64/00; G01S 5/02; H04W 4/029

(52) U.S. Cl. CPC H04W 64/006; G01S 5/0284; H04W 4/029

(57) ABSTRACT

A centralized extended proximity ranging method for use in a networked ecosystem having an initiator node in an initiator network, relay nodes, and a target node in a target network includes accessing a recorded activation profile. The ecosystem may be constructed as an Internet-of-Things (IoT) ecosystem. The activation profile includes a desired action or service of the target node, e.g., an automation robot. A proximity ranging protocol estimates a range to one or more neighboring nodes of the relay nodes within a range limit of the initiator node. The target node is outside of the range limit. The method includes identifying a ranging path between the initiator and target nodes, including communicating ranging parameters between nodes of the initiator and target networks. The ranging path includes the designated node. The method includes requesting performance of the desired action or service over the ranging path.

### INTRODUCTION

Advancements in global automation technology have led to the adoption of network-based management of a myriad of storage, diagnostic, maintenance, sensors, actuators, control, and other operations. For example, at-home charging operations of modern electric vehicles (EVs) or plug-in hybrid electric vehicles (PHEVs) may be scheduled and managed using “smart garage” network connectivity. Other aspects of smart garage automation include smartphone-based monitoring and opening/closing operation of garage doors, as well as control of climate settings such as temperature, humidity, and air quality. Security systems may be similarly managed from a remote location. Within a representative garage environment, such automation also facilitates inventory, tool, and parts management along with a host of other functions. Similar technologies may be applied to other environments, including but not limited to a user's home or office.

The effective implementation of global automation solutions relies on accurate proximity ranging between connected devices, more generally referred to as communication nodes. Proximity ranging in the context of global smart garage automation and other exemplary Internet of Things (IoT) applications generally refers to the process of determining a distance between such nodes. Common proximity ranging techniques using electromagnetic waves include estimating a distance between a transmitter and a receiver based on received signal strength, based on the amount of time it takes for a transmitted packet from a transmitter to reach the receiver, i.e., time-of-flight, and other techniques. The transmitted signals may be ultra-wideband (UWB), Bluetooth Low Energy (BLE), Wi-Fi, etc. However, such techniques are only capable of measuring a proximity range between two devices within each other's immediate proximity. For some emerging home or industrial IoT use cases demanding low-latency, or those in which not all IoT devices belong to the same network or trust circle, such maximum proximity limits for range measurements may result in a suboptimal user experience.

### SUMMARY

The present disclosure pertains to a centralized proximity ranging protocol for use in a local networked ecosystem. The solutions presented herein—referred to hereinafter as “multi-hop” proximity ranging—are intended to address potentially problematic issues such as ranging latency, ranging limit, security/privacy, out-of-range service activation, network overload, and suboptimal customer experience in an Internet of Things (IoT) environment, e.g., the above-noted global smart garage application, or in industrial applications in which devices located on different wireless networks (possibly in different buildings or operational areas) are required to communicate with each other. The proposed centralized proximity ranging protocol may be used to govern end-to-end proximity ranging in the above-noted local networked ecosystem, within which an initiator node requests multiple connected relay nodes to estimate the distance to an out-of-range target node. The disclosed protocol may be implemented to dynamically estimate the distance between the initiator and target node using a centralized model, embodiments of which are described in detail below.

The centralized approach envisions use of a central controller, e.g., a cloud-based server, backend device, or local server, operable to communicate with the target node for the above-noted service activation. Without cloud or on-site communication between different buildings, for example, range-based applications are usually not implementable in a multi-building scenario. In instances in which nodes/devices that require ranging do not collectively reside on one communication network, the present strategy in may seek an intermediate node or nodes using the central controller and thereby orchestrate extended multi-hop ranging in accordance with the disclosure.

In a particular embodiment, a centralized proximity ranging method and associated networked ecosystem are disclosed herein. The networked ecosystem includes an initiator node located in/on a first wireless network (“initiator network”). The networked ecosystem includes a plurality of relay nodes including a designated node, and a target node located in a second wireless network (“target network”). The target node is out of range of the initiator node. The centralized ranging method in a possible embodiment includes accessing a recorded activation profile, in/from a computer readable storage medium, as a desired action or service of the target node, and then identifying a ranging path(s) between the initiator and target nodes. Identifying the ranging path in some embodiments is performed by or with the assistance of a central controller in communication with the initiator and target networks. This step includes communicating ranging parameters between the initiator network and the target network. The ranging path includes the designated node, i.e., an ultra-wide band (UWB) capable or another smart node located in the target network. The method includes requesting performance of the desired action or service by the target node over the ranging path.

Identifying the ranging path may include estimating, via a central controller using a proximity ranging protocol, respective proximity ranges to one or more neighboring nodes of the plurality of relay nodes within a range limit of the initiator node, respective nodes of the one or more neighboring nodes being in the initiator network of the initiator node or the target network of the target node. Such an embodiment may include dynamically determining the internodal distance between the initiator and target nodes based at least in part on the respective proximity ranges to the one or more neighboring nodes. This embodiment also includes requesting the desired action or service via the one or more neighboring nodes upon determining that the internodal distance between the initiator and target nodes is not greater than an activation threshold.

The central controller may be configured as or include a cloud-based server, and in which case identifying the ranging path is performed using the cloud-based server.

Determining the internodal distance between the initiator and target nodes may be further based on estimating an angle-of-arrival of a signal exchanged between the initiator node and a neighboring node of the plurality of relay nodes, and estimating an angle-of-arrival of a signal exchanged between the target node and the neighboring node. The method may also include estimating the range to the neighboring node based on a time-of-arrival of a signal sent by the initiator node to the neighboring node. Upon estimating the range to the neighboring node, the method may include instructing the neighboring node to estimate the range between itself and the target node.

The designated node in one or more implementations is configured with authentication, security, and/or privileges to interact with one or more of the relay nodes. Additionally, the designated node may be configured with authentication, security, and/or privileges to interact with the initiator node or the target node, with the initiator node and/or the target node not being capable of directly interacting (or not allowed to directly interact) with any other node on a network of which the designated node is a member.

Embodiments of the method includes establishing a communications link between the initiator network and the target network, via a central controller, using a plurality of wireless routers. Accessing the recorded activation profile in the computer readable storage medium in such an embodiment may include accessing the recorded activation profile in memory of the central controller and establishing communication links between the central controller, the initiator node, and the target node. The method may also include communicating, via a wireless router, with: (a) the initiator node and a first set of the relay nodes, and (b) a second set of the relay nodes and the target node via a border router, wherein the plurality of wireless routers includes the wireless router and the border router.

Continuing with the summary of the present method, the method in one or more embodiments may include measuring a time-of-arrival and an angle-of-arrival of a signal sent by the initiator node to one or more of the relay nodes. Measuring the time-of-arrival and the angle-of-arrival of the signal may be performed using the designated node, and wherein the designated node is an ultra-wideband (UWB)-capable node.

The target network may be constructed as a proprietary network, in which case the method may use the designated node as a proxy node to initiate a proximity ranging session during a commissioning process of the initiator node or the target node. The commissioning process may include authorizing a use of the initiator node or the target node during the proximity ranging session.

Aspects of the disclosure include using a shortest distance algorithm to determine a nodal path from the initiator node to the target node through one or more of the relay nodes, as well as periodically checking a status and connectivity of the one or more relay nodes at a sampling frequency and adjusting the sampling frequency based on a characteristic of the one or more relay nodes.

The initiator node may include (or be part of) a smartphone or a vehicle. The target node may include (or be part of) a smart home device. Accessing the recorded activation profile in such an embodiment may include accessing a recorded light, door, appliance, and/or vehicle charging station setting of the smart home device.

Another aspect of the disclosure includes a networked ecosystem having a node operable for communicating ranging parameters between an initiator network and a target network, a wireless router, a border router, and an initiator node located in the initiator network. The networked ecosystem further includes a plurality of relay nodes, including at least one transit node and at least one smart node. The at least one smart node includes a designated node. A target node is in/is a member of the target network. The target network for its part is located outside of a range limit of the initiator node. The node operable for communicating the ranging parameters is in communication with the initiator network and the target network via the wireless router and the border router, respectively.

As part of this embodiment, a computer-readable storage medium contains a recorded activation profile including a desired action or service of the target node. The networked ecosystem is configured to use a centralized proximity ranging protocol to access the recorded activation profile and identify a ranging path between the initiator node and the target node, with the ranging path including the designated node. The networked ecosystem then requests performance of the desired action or service over the ranging path

In another implementation, the networked ecosystem includes an initiator node located in a first area as part of an initiator network, the initiator node having a UWB capability, and a plurality of relay nodes including at least one transit node and at least one smart node. The smart node also includes the UWB capability and includes/is constructed as a designated node. The target node, located in a second area as part of a target network, is outside of a range limit of the initiator node and configured as an automation robot in this representative construction. A computer readable storage medium contains an activation profile in the form of a desired action or service of the target node.

A cloud-based central controller in this embodiment is operable for communicating ranging parameters between the initiator network and the target network. A first wireless router connects the initiator network to the cloud-based central controller. A second wireless router connects the target network to the cloud-based central controller. The central controller uses a centralized proximity ranging protocol to access the recorded activation profile and identify a ranging path between the initiator node and the target node. The possible ranging path includes the designated node. The central controller may request performance of the desired action or service over the ranging path.

The above-summarized features and other features and advantages of this disclosure will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1A is an illustration of a representative networked ecosystem configured to use a centralized extended multi-hop proximity ranging strategy as set forth herein.

FIG. 1B is an illustration of an alternative industrial networked ecosystem that may host the centralized extended multi-hop proximity ranging strategy of the present disclosure.

FIG. 2 is a block diagram illustrating a protocol for implementing the centralized extended multi-hop ranging strategy of the present disclosure.

FIG. 3 is a schematic illustration of a multi-building environment in which the present centralized extended multi-hop proximity ranging strategy may be applied.

FIGS. 4A and 4B illustrate models for performing the centralized extended multi-hop proximity ranging strategy in accordance with aspects of the disclosure.

FIG. 5 is a flow chart describing a method for implementing the centralized extended multi-hop proximity ranging strategy in accordance with an embodiment of the disclosure.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

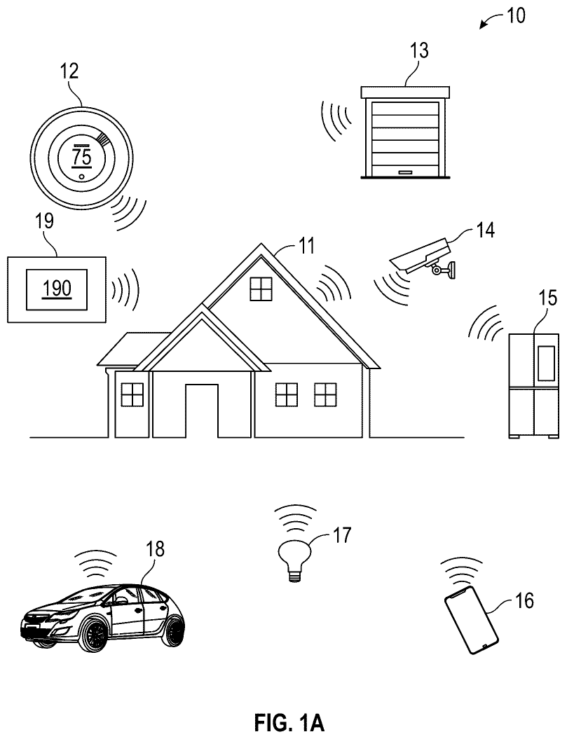

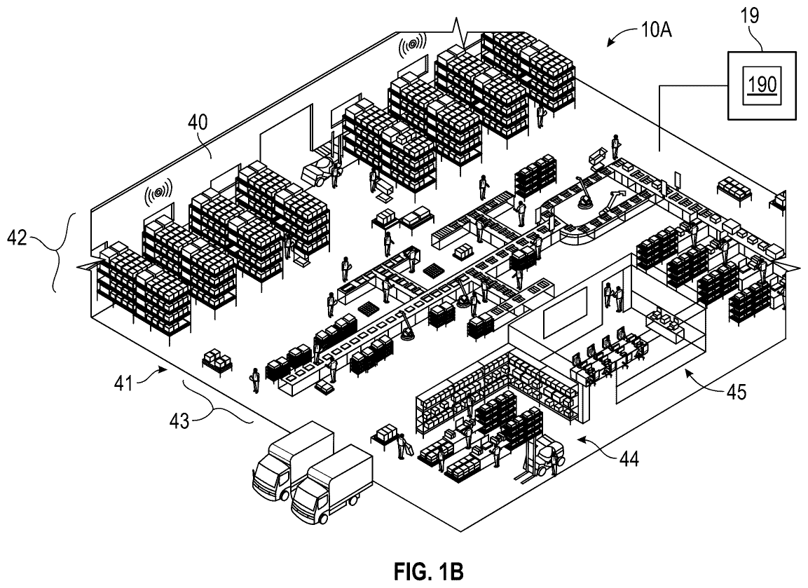

Referring now to the drawings, wherein like reference numbers refer to like features throughout the several views, a local internet-of-things (IoT) networked ecosystem 10 is illustrated in FIG. 1A in which multiple communication nodes are in networked communication with one another as set forth herein. The networked ecosystem 10 shown in FIG. 1A is described as a non-limiting global automated smart garage of a smart home 11. In such an embodiment, the above-noted nodes may include one or more of, e.g., a wireless/Wi-Fi-enabled thermostat 12, a garage door 13, a security camera 14, an appliance 15, a smartphone 16 or other smart device, e.g., a smart watch or another wearable, etc., a light bulb 17, a vehicle 18, etc. As will be described below, the networked ecosystem 10 also includes a computer readable storage medium 19 having an activation profile 190 recorded or stored therein, the activation profile being a desired action or service of a target node or device as described below. The activation profile 190 is therefore accessible from the computer readable storage medium 19 as part of the present approach. The actual host or location of the computer readable storage medium 19 may vary depending on the embodiment, and thus is depicted as separate from the various networked devices in FIG. 1A.

In FIG. 1B, an alternatively constructed networked ecosystem 10A is shown as an automated industrial facility, e.g., a manufacturing plant or warehouse. Walls 40 (one of which is shown in FIG. 1B) and a floor 41 delineate work areas for performance of various related operations. For example, the networked ecosystem 10A may include an inventory section 42, e.g., shelves or part/component bins, one or more production lines 43, a receiving area 44, and office space 45 among other possible areas or workspaces. In such an embodiment, the above-noted nodes may correspond to varies computers, wireless devices, sensors, smart devices, etc., including passive radio frequency identification (RFID) tags, barcodes/bar code readers, and the like. As with the networked ecosystem 10 of FIG. 1A, the networked ecosystem 10A of FIG. 1B also includes a computer readable storage medium 19 having the activation profile 190 recorded or stored therein or accessible thereby. The actual host/location of the computer readable storage medium 19 within the illustrated networked ecosystems 10 and 10A may vary depending on the embodiment, and thus is depicted as separate from the various networked devices in FIGS. 1A and 1B.

Descriptions of the smart home, smart garage implementations, and smart facilities of FIGS. 1A and 1B are used hereinafter solely for illustrative consistency, with the actual number and construction of the constituent nodes participating in the networked ecosystems 10 and 10A varying with the intended application. For simplicity and consistency, the networked ecosystems 10 and 10A of respective FIGS. 1A and 1B will be described hereinafter with reference to the networked ecosystem 10A without limiting the present teachings to the FIG. 1B embodiment.

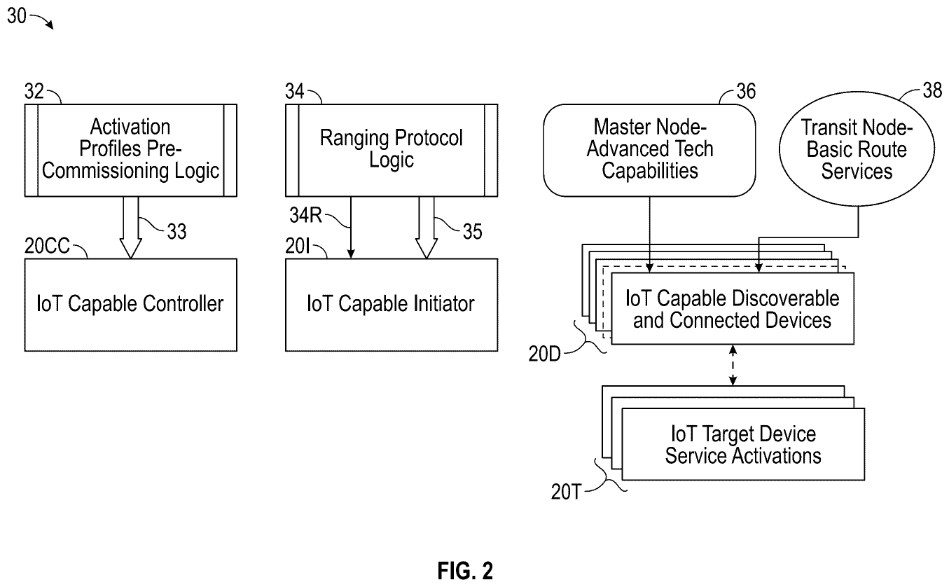

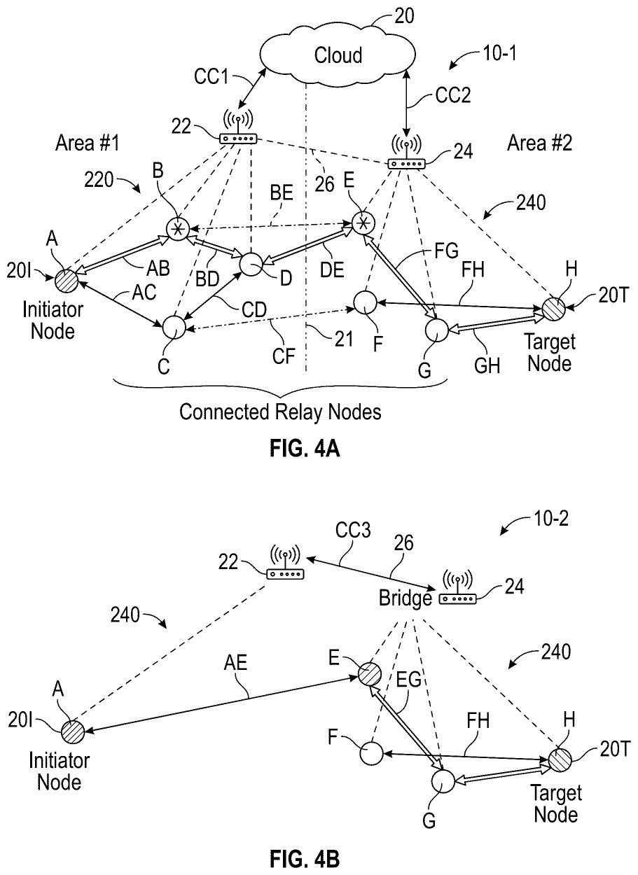

Referring briefly to FIGS. 4A and 4B, both of which are discussed in greater detail below, the networked ecosystem 10A of FIG. 1B includes an initiator node 201, e.g., including an ultra-wideband (UWB) capability, and a plurality of connected relay nodes 20R, with the relay nodes 20R including at least one lower-capability transit node and at least one higher-capability “smart” node as described in detail below. The networked ecosystem 10A also includes a target node 20T that is located outside of a range limit of the initiator node 201, and thus out of direct communication therewith. The above-noted computer readable storage medium 19 contains the recorded activation profile 190 in this embodiment. The networked ecosystem 10A as set forth herein is also configured to use a proximity ranging protocol 30 (FIG. 2) to estimate respective ranges to one or more neighboring nodes of the plurality of relay nodes 20R within a range limit of the initiator node 201, and to dynamically determine an internodal distance between the initiator node 201 and the target node 20T using the respective ranges.

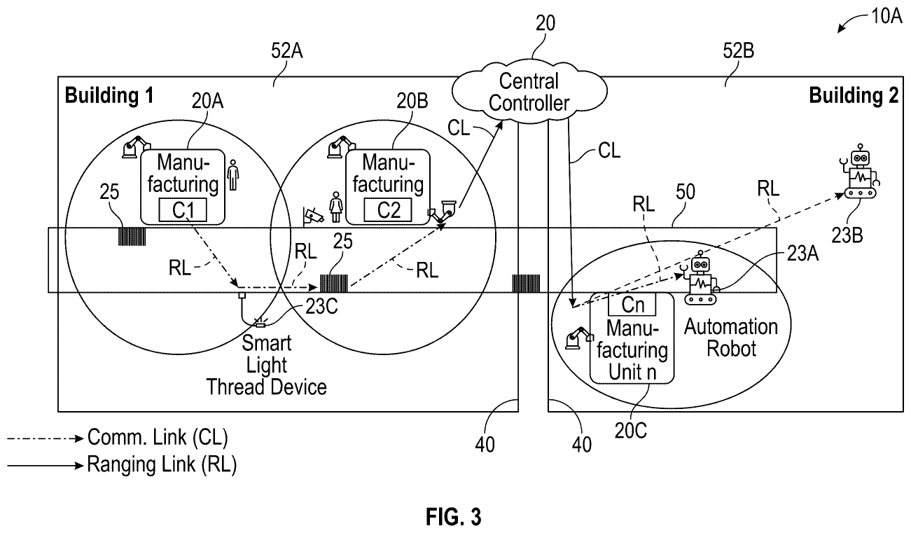

As contemplated herein, proximity ranging between nodes of the networked ecosystem 10A of FIG. 1B and alternative embodiments thereof, including the networked ecosystem 10 of FIG. 1A, involves accurately estimating inter-nodal distances. For example, and referring briefly to FIG. 3, a manufacturing, assembly, kitting, or order fulfilment operation may occur across multiple areas or buildings. Multiple buildings within a manufacturing plant will tend to have multiple controllers or routers, which in turn are connected to a centralized controller, e.g., a local controller or a cloud-based controller. Ranging between two devices located in two different buildings may require cloud support. The centralized extended multi-hop ranging approach of the present disclosure may be used in such cases.

A simplified scenario is shown in FIG. 3 in which two areas in the form of exemplary buildings, a first building (Building #1) having the initiator network and a second building (Building #) having the target network, are separated from each other by walls 40. Within Building #1, a conveyor 50 may extend past local controllers 20A and 20B. Products may be tagged with bar codes 25 to help track production progress. Exemplary devices operable as nodes herein may include a smart light Thread® device 23C and an RFID asset tracking sensor 23D. As appreciated in the art, Thread is a low-power, low-bandwidth mesh networking protocol similar in some respects to open-source Zigbee, Z-Wave, and other “smart home” IoT protocols, but not requiring use of a central hub or bridge. Within Building #2, another local controller 20C may be used in conjunction with the conveyor 50 and possibly one or more automation robots 23A, 23B. Extended-range service activation in this scenario may entail the local controller 20A seeking assistance from the out-of-range automation robot 23B. The robot 23B may be multi-tasked and thus required to perform multiple distinct functions such as asset management, quality control, defect analysis, repair, maintenance, etc.

In this representative embodiment of the networked ecosystem 10A of FIG. 3, with communication links indicated as CL and ranging links indicated as RL, a transmitting node such the local controller 20A or 20B of Building #1, e.g., manufacturing controllers, may be required to locate the automation robot 23A or 23B within Building #2, possibly via one or more (i.e., an integer “n”) additional local controllers (Manufacturing Unit n). However, the automation robot 23A, 23B is out of range of the local controllers 20A and 20B. Ranging and localization may therefore occur herein via one or more intervening RFID asset tracking sensors 23D or other device nodes, e.g., to request inspection of a potentially faulty part as the part is transported on a conveyor belt 50. Regardless of the construction of the networked ecosystem 10A of FIGS. 1B and 2, the networked ecosystem 10A benefits in a variety of ways from the centralized extended multi-hop proximity ranging technique described herein.

As an example, modern proximity ranging techniques for typical smart home/garage, manufacturing plants, and other local network applications are conducted in accordance with the open-source Matter™ (MATTER) standard, which in turn is directed to managing the communication of locally networked devices. In some applications, a device/node may send activation commands to a target node based at least in part on the proximity of the target node. However, users of the networked ecosystem 10 of FIG. 1A, the industrial IoT use case of FIG. 1B, or other home, office, industrial, medical, or other use cases may benefit from reduced latency and the improved customer experience stemming therefrom.

For instance, a user walking from a kitchen to a garage of their smart home 11 (FIG. 1A) may, upon reaching the garage, expect to find the garage door 13 already fully open and their vehicle 18 disconnected from a charging station (not shown), and/or conditioned according to custom settings of the user approaching the vehicle 18 where the conditioning may include one or more of seat adjustments, mirror adjustments, cabin temperature settings, and others. The user's overall experience may be degraded somewhat if the user is left waiting for the scheduled actions to be completed before entering the vehicle 18. The extended multi-hop strategy is therefore directed toward extending communication distances and reducing response latency, preventing out-of-range activation errors, and improving the overall customer experience within a local network such as the representative networked ecosystem 10 of FIG. 1A or 10A of FIG. 1B.

Although omitted for illustrative simplicity from the various Figures, the hardware associated with the various nodes of FIGS. 1A and 1B may be in the form of one or more Application Specific Integrated Circuit(s) (ASIC), Field-Programmable Gate Array (FPGA), electronic circuit(s), central processing unit(s), e.g., microprocessor(s) or processors, and associated computer readable storage medium/memory. Non-transitory components of such memory, including the computer readable storage medium 19 of FIG. 1, are capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Using such hardware and associated antenna, receivers, and transmitters residing at the various nodes, therefore, information may be exchanged wirelessly between nodes, e.g., via Wi-Fi, Zigbee, Bluetooth™, Bluetooth™ Low-Energy (BLE), etc.

Referring to FIG. 2, an extended multi-hop proximity ranging protocol 30 may be used in the decentralized and centralized alternative embodiments described below with reference to FIGS. 4A and 4B, respectively. The extended multi-hop proximity ranging protocol 30 is illustrated as a block diagram for illustrative clarity. In an IoT context, actions are triggered at a target node based on predetermined or prerecorded user profiles. For example, a user of the networked ecosystem 10 of FIG. 1A walking from a kitchen to a garage of the illustrated smart home 11 may, upon reaching the garage, expect the temperature setting, and/or seats and mirrors of vehicle 18 to be adjusted according to their custom levels. Similarly, a user walking around the smart home 11 may set profiles for when to turn on the light bulb 17, charge or stop charging the vehicle 18, etc., relative to the user's position in the smart home 11. Similar expectations may be present in the industrial embodiment of FIG. 1B for other networked devices.

Although such profiles are already set, the extended multi-hop proximity ranging strategy disclosed herein allows extension of the distance between the initiating and target nodes relative to existing strategies, as noted above. This extended range may result in a better user experience, particularly since some actions such as opening/closing doors, disengaging electric vehicle (EV) charging handlers, or custom adjustments within a vehicle in preparation for a specific driver take time to complete after initiation, and thus, earlier activation of them enabled by the enhanced proximity ranging, helps reduce or eliminate the time the user has to wait for their completion. Programmed actions are thus able to commence sooner than they otherwise would be without benefit of the present teachings.

In FIG. 2, block 32 represents such activation profiles, which may be communicated to an IoT-capable controller 20CC as indicated by arrow 33. Such a controller 20CC may be variously embodied as a master/“smart” node in a centralized ecosystem model 10-1 as shown in FIG. 4A or 10-2 (FIG. 4B) as described below. The extended multi-hop proximity ranging protocol 30 also include a proximity ranging block 34, which as represented by arrow 35 is deployed on or hosted by an initiating node 201, e.g., the vehicle 18 of FIG. 1, the smartphone 16, etc. The proximity ranging block 34 may provide the activation rules 34R needed for operating in accordance with the disclosure.

Also included in the extended multi-hop proximity ranging protocol 30 of FIG. 2 are various relay nodes 20R, including IoT capable/discoverable connected relay devices 20R within the networked ecosystem 10 operating as either lower-capability transit nodes or higher-capability smart nodes as explained below. Block 36 represents such advanced technological capabilities such as lower power limitations, higher computational capabilities, angle-of-arrival (AoA) estimation capability, or others, for the smart nodes, while block 38 represents the lower capabilities of transit nodes, e.g., RFID tags and possibly other low-power IoT devices typically in a sleep mode, thus requiring time to wake up and take actions such as proximity ranging. The extended multi-hop proximity ranging protocol 30 also considers operation of the target node 20T, i.e., the intended performer of actions initiated via service activations from the initiating node 201. The examples that follow rely on the architecture of the extended multi-hop proximity ranging protocol 30 of FIG. 2.

CENTRALIZED EXTENDED MULTI-HOP RANGING: Referring to FIG. 4A, centralized ecosystem model 10-1 illustrates various devices/nodes that are nominally labeled A-H for simplicity. FIG. 4A is an exemplary implementation in which a central controller, in this case a cloud-based or other central controller 20, is leveraged to reach an out-of-range target node 20T for activation thereon of a desired action or service. Such leveraging may be performed using cloud-based or external edge networks. While the present teachings are sufficiently flexible to conduct centralized multi-hop ranging with or without network separation, FIG. 4A illustrates a representative case in which two areas (Area #1 and Area #2), e.g., of the exemplary plant floor of FIG. 3, are separated from each other by a border 21, for instance the walls 40 of FIG. 1B when Areas #1 and #2 represent different structures, designated workspaces, buildings, or other areas. The present teachings may be used for ranging session resource management and communication in this or other densely deployed network environments.

In FIG. 4A, node A represents an initiator node 201, i.e., a node/device that initiates a request to communicate with and request a desired action or service of a target node 20T (node H) located out-of-range of the initiator node. Nodes B, C, D, E, F, and G represent relay nodes, most or all of which may be configured as the above-described transit nodes and none, one, or more of which may be configured as more computationally capable smart nodes. The centralized ecosystem model 10-1 of FIG. 4A also includes additional network nodes, in this case a cloud-based controller 20, a wireless router 22, e.g., a Wi-Fi, Thread®, MATTER, or Zigbee router, and a border router 24, likewise a Wi-Fi, Thread®, MATTER, or Zigbee border router. Nodes B and E in this embodiment act as so-called “anchor” nodes (described below), with this anchor status denoted in FIG. 4A by an asterisk (*). In general, if a device operating in Area #1 uses the wireless router 22 in the form of a Zigbee network router to activate a device in Area #2, e.g., operating a MATTER network via the border router 24, the device ranges/localizes with a given designated node in the MATTER network, in this case node E (*). The designated node E would then reach the target node 20T via one or more intermediate nodes within the MATTER network, e.g., node G.

In a home charging application in which the smart home 11 (FIG. 1A) is connected to electric vehicle supply equipment (EVSE) in the form of an electric charger, the charger may act as a designated node, with a user approaching the smart home 11 ranging through the designated node. Thus, the use of designated nodes may be used to enhance security. Thus, identifying a ranging path between the initiator node 201 and the target node 20T herein, e.g., via the central controller 20, may entail using a ranging path that includes the designated node. This action in turn may include estimating, via the central controller 20 using the proximity ranging protocol of FIG. 2, respective proximity ranges to one or more neighboring nodes of the plurality of relay nodes within a range limit of the initiator node 201. Respective nodes of the one or more neighboring nodes in this exemplary case are in the initiator network or the target network. Upon estimating the range(s) to the neighboring node(s), each neighboring node may be instructed to estimate the range between itself and the target node 20T.

In FIG. 4A, the present approach may assume the initiator node 201 is already part of the exemplary MATTER network. This assumption may be expanded on. The initiator node 201 or target node 20T may in some instances undergo a commissioning process to join the MATTER network but may still use the above-noted designated node as a proxy to initiate/be part of a new multi-hop proximity ranging session. For instance, the vehicle 18 (FIG. 1A) may not be part of the MATTER network but still use an electric vehicle supply equipment (EVSE) charging station (e.g., part of an original equipment manufacturer (OEM) network or the exemplary MATTER network) as a proxy to invoke action on another device, such as a television set or a lighting system, as the commissioning process continues.

In the illustrated deployment space, each node has two functions: (i) communication, and (ii) ranging. The ranging function includes time-of-arrival (ToA) for ranging and angle-of-arrival (AoA) for localization. Functionalities (i) and (ii) may be from the same wireless technology, e.g., Wi-Fi, or from different wireless technologies such as Wi-Fi for communication and ultra-wideband (UWB) for ranging/localization. Additionally, each node connects to the central controller 20 (a local or cloud-based server or back end) through respective wireless communication networks, e.g., Wi-Fi, THREAD, Zigbee, etc., with corresponding gateways. The initiator node 201 is part of an initiator network, while the target node 20T is part of a target network, for instance a proprietary network. The initiator node 201 must therefore communicate with the target node 20T via the intervening central controller 20 in the various embodiments. As shown by dotted lines BE and CF in FIG. 4A, the present multi-hop approach has the flexibility to enable or disable internetwork ranging/localization. Thus, in some implementations the central controller 20 determines the ranging path(s) from one node to another, and in particular from the initiator node 201 to the target node 20T.

As appreciated in the art, the border router 24 of FIG. 4A may be used to connect a local network to the internet via the wireless router 22, or to a wider network or networks. As its name implies, the border router 24 may be located at an edge of a network, in this case the initiator network/first wireless network that is served by the wireless router 22. Functionally, the border router 24 is used to route data traffic and thus act as a gateway between a local network and one or more external networks. The wireless router 22 for its part is used to communicate with nodes within a given local network, e.g., nodes A, B, C, and D in the non-limiting simplified embodiment of FIG. 4A, as represented by link lines 220. The wireless router 22 may also be connected to the internet, for instance via an ethernet box (not shown) that the wireless router 22 is connected to, connection to a fiber or coax cable, a cellular link, or others. The border router 24 connects other nodes, nominally nodes E, F, G, and H, to the wireless router 22 via the central controller 20 as indicated by arrows CC1 and CC2. within FIG. 4A, lines 220 and 240 represent wireless communication pathways within the networked ecosystem 10.

The centralized nature of the present extended multi-hop strategy proceeds with the following assumptions: (1) some of the nodes are ultra-wideband (UWB)-capable nodes, e.g., the smartphone 16 or other mobile device, or the vehicle 18 of FIG. 1A, a moving automation robot 23A or 23B (FIG. 3), etc., (2) each UWB-capable node has the capability to measure time-of-arrival (ToA) or angle-of-arrival (AoA), e.g., using multiple antennas, such that one or more UWB-capable nodes are able to determine the relative location of other UWB nodes, and (3) each UWB-capable node is connected to the cloud-based controller 20, e.g., an external central server capable of communicating ranging parameters between an initiating network in Arca #1 and a target network of Area #2 of FIG. 3, through various wireless networks as shown. As appreciated in the art, UWB-capable sensors are configured to use a designated portion of the radio spectrum, typically 3.1 GHz to 10.6 GHz, for the purpose of high-speed data transmission over relatively short distances.

Among other attendant benefits, low-power UWB-capable sensors when used in the context of the centralized ecosystem model 10-1 of FIG. 4A enable accurate localization and real-time tracking of objects of interest. As the above-noted frequency range is widely spread, UWB sensors are less susceptible to interference from Wi-Fi or Bluetooth™ devices, making UWB sensors optimal for IoT applications of the type contemplated herein. Thus, detecting the respective ranges to the one or more neighboring nodes within the scope of the disclosure may include using one or more UWB-capable nodes to measure a time-of-arrival (ToA) and an angle-of-arrival (AoA) of a signal from the one or more neighboring nodes.

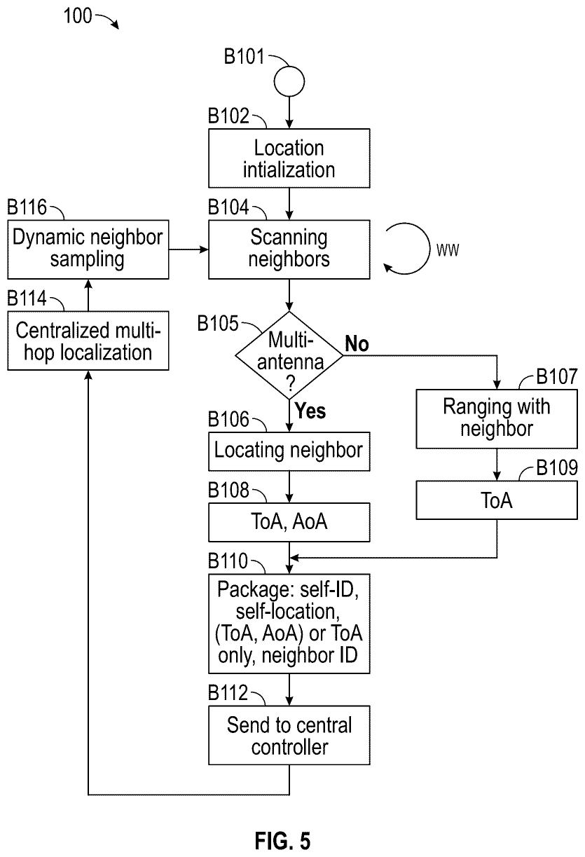

Features of the centralized multi-hop strategy of FIG. 4A include local distance map creation, centralized multi-hop localization, and dynamic neighbor sampling. For local distance map creation, each UWB-capable node periodically scans neighboring nodes, the periodicity of the scan being determined by the mobility of the network or a determination of the capabilities of the neighboring nodes. One option includes communicating from a local network in Arca #1 to the cloud-based controller 20, and ultimately to the target node 20T via the central controller 20. Another option may be used when links BE and DF do not exist, in which case the initiator network may localize within its area, i.e., Area #1, and communicate through the central controller 20 to infer locations of nodes located in Area #2. A possible approach for implementing centralized extended multi-hop localization is described below with reference to FIG. 5. Regarding dynamic neighbor sampling, a shortest distance or path algorithm may be used to find the path, with scanning periodicity increased on ranging path nodes. Thus, the proximity ranging method described herein may include using a shortest distance algorithm to determine a nodal path from the initiator node 201 to the target node 20T through the one or more neighboring nodes.

Referring briefly to FIG. 4B, an alternative centralized ecosystem model 10-2 is shown that represents a configuration on a smaller scale than that which is depicted in FIG. 4A. Functions of the central controller 20 of FIG. 4A may be performed using other nodes. A bridge CC3 exists between the routers 22 and 24, e.g., a wireless point-to-point network connection. In a possible use case, a mobile device employed as the initiator node 201 in an original equipment manufacturer (OEM)-specific network may attempt to activate a device in a MATTER network. The mobile device, e.g., the smartphone 16 of FIG. 1A, may range/localize with a designated node in the MATTER network/OEM network in this event such that the mobile device reaches the target node 20T solely via intermediate nodes of the MATTER network, e.g., nodes E, F, and G in the simplified network example of FIG. 4B, including the designated node. The designated node may be configured with authentication, security, and/or privileges to interact with the initiator node 201 or the target node 20T. The initiator node 201 and/or the target node 20T in one or more embodiments is also not capable of directly interacting (or not allowed to directly interact) with any other node on a network of which the designated node 20T is a member.

Referring now to FIG. 5, local distance map creation as noted above may be implemented using an algorithm or method 100. For clarity, each process step of the method 100 is described as a separate set of code and organized as logic blocks. Depending on the action, the various blocks may be performed by a particular node of the networked ecosystem 10 (FIG. 1A) or 10A (FIG. 1B).

Upon starting the method 100 at block B101, and once again referring to the exemplary embodiments of FIGS. 4A and 4B, the method 100 proceeds to block B102 (“Location Initialization”), whereupon the initiator node 201 initializes location of the out-of-range target node 20T. The method 100 then proceeds to block B104.

Block B104 (“Scanning Neighbors”) entails communicating via the initiator node 201 with neighboring nodes (one or more of the relay nodes) within its communication range. As some of the neighboring nodes may be in a sleep or low-power mode, such nodes will be triggered to wake up at block B104 as indicated by arrow WW. Block B104 or other portions of the method 100 in some embodiments therefore include establishing communication links between the central controller 20, the initiator node 201, and the target node 20T, and then communicating, via a wireless router, with: (a) the initiator node 201 and a first set of the relay nodes, and (b) a second set of the relay nodes and the target node 20T via the border router 24 (FIG. 4A). The plurality of wireless routers in this case includes the wireless router 22 and the border router 24. The method 100 thereafter proceeds to block B105.

At block B105 (“Smart Node?”) of FIG. 5, the method 100 includes determining whether the neighboring node that was scanned at block B104 is a master/smart node as described above. Block B104 therefore entails ascertaining the compute functionality of the neighboring nodes in terms of one or more neighboring nodes being a lower capability transit node or a higher capability smart node, i.e., one having multiple antennas and capable of determining time-of-arrival (ToA) and angle-of-arrival (AoA). The method 100 proceeds to block B106 when the neighboring node is a smart node, and to block B107 when the neighboring node is a transit node.

Block B106 (“Locating Neighbor”) involves initializing locating a neighboring node having smart capabilities. The method 100 thereafter proceeds to block B108.

Block B107 (“Ranging w/Neighbor”) involves locating a neighboring node that lacks the requisite multi-antenna structure needed for enabling smart capabilities. The method 100 thereafter proceeds to block B109.

Block B108 (“ToA, AoA”) of FIG. 5 includes determining the time-of-arrival (ToA) and the angle-of-arrival (AoA) of the neighboring node located at block B106. Time-of-arrival involves a receiver node measuring the time at which a transmitted signal is received from a neighboring node. Once time-of-arrival has been measured, the internodal distance is easily calculated as the product of ToA and signal speed, i.e., light speed. Angle-of-arrival (AoA) as the name implied determines the direction from which a signal arrives at a receiving node, with an antenna array detecting the signal with a slight phase and amplitude difference. AoA is then determined based on the measured phase and amplitude differences, e.g., using beamforming or other suitable algorithms. Measuring the time-of-arrival and the angle-of-arrival of the transmitted signal is performed using the designated node as noted above, with the designated node configured as an ultra-wideband (UWB)-capable node in one or more embodiments. The method 100 proceeds to block B110 once the ToA and/or AoA have been determined.

At block B109 (“ToA”), the initiator node determines the time-of-arrival (ToA) of the neighboring node located at block B106. As the receiver node is a transit node in this instance, time-of-arrival information is available to the receiver node, while angle-of-arrival (AoA) information is not. The method 100 proceeds to block B110 once the ToA has been determined.

At block B110 (“Package”), the initiator node 201 generates a data package of relevant information for communication to the neighboring node. The data package may include, e.g., the unique identifier of the initiator node, time-of-arrival (ToA) and/or angle-of-arrival (AoA) information from blocks B108 or B109 as described above, a unique identifier of the neighboring node (e.g., an alphanumeric string or bit code, etc.). The method 100 thereafter proceeds to block B112.

At block B112 (“Send Package”) of FIG. 5, the initiator node 201 transmits the package from block B110 to the central controller 20 when using the representative embodiment of FIG. 4A or 4B as described above. Embodiments of the proximity ranging method in general therefore include transmitting the data package to the one or more neighboring nodes, with the data package including a unique identifier and location of the initiator node 201, the ToA and the AoA, and a unique identifier of the one or more neighboring nodes. In response to the data package being received from the initiator node 201, block B112 or another block may include sending a response data package via each of the one or more neighboring nodes, including sending the unique identifier of each of the one or more neighboring nodes, the angle-of-arrival of reception of the data package, and the time-of-arrival of the data package. The method 100 thereafter proceeds to block B114.

Still referring to FIG. 5, the method 100 next includes performing a centralized multi-hop localization algorithm using the information in the packet from block B112, e.g., via the central controller 20 of FIG. 4A or point-to-point communication in FIG. 4B. A representative set of code usable for this purpose is as follows.

Centralized Multi-hop Localization Algorithm:

```
Begin:
Initialize graph G with received node packages
For each node i in G
    if node i has no location data or is mobile
      find neighbor nodes θ whose self-locations are available
      if # of master node > 1 or # of transit node > 3
        calculate node I location based on neighbor's location, ToA and AoA
        update node i location
        add node i, node in θ and their edge in graph G′
mindist, path = Findshortestdistance (initiator, target, graph G′)
if mindist > 0 or try > maximal tries
  return path
else
  try ++
  goto: Begin
```

In the above algorithm, graph G defines the above-noted anchor node as a node whose location (self-location) is predetermined during installation and fixed during execution of the algorithm. In the representative smart home 11 of FIG. 1A, the anchor node may be the appliance 15, a television, etc. In the industrial plant environment of FIG. 1B, the anchor node may be a particular machine, cabinet, or other node. Anchor nodes are neighboring nodes of each other, even when not located in close relative proximity. Location of anchor nodes may be established based on a map if the anchor nodes are unable to range with each other. This distance may be set to zero so that the location of the target node 20T may be quickly inferred. Non-anchor nodes iteratively determine their self-location through a neighboring smart node having self-location capabilities or via three neighboring transit nodes with self-location capabilities. Using dynamic sampling in some implementations, a weighted solution may be implemented by ranking nodes with higher ranging frequency if such nodes are on a ranging path.

Continuing the discussion of FIG. 5, at block B116 (“Dynamic Neighbor Sampling”) the initiator node 201 receives the ranging path from block B114 and performs a dynamic neighbor sampling routine. As appreciated in the art, such a technique may be used to monitor and manage the status of various neighboring nodes. In general, each node maintains a local list or table of its neighboring nodes, i.e., those within a distance limit for communication, which in turn may be several dozen meters or less depending on the embodiment. Using dynamic neighbor sampling, the initiator node 201 or other sampling node periodically checks the status and connectivity of the neighboring nodes at a sampling frequency. The sampling frequency may be dynamically adjusted upward or downward as needed based on a characteristic of the one or more neighboring nodes, for example node behavior/the presence of changes or abnormalities, neighboring node movement, speed of movement, rate of a selected neighboring node going out of proximity range limit, etc. Higher sampling frequencies may be used when the node is mobile or on the path determined at block B114. Method 100 then returns to block B104.

Centralized extended multi-hop proximity ranging service activation in accordance with the present disclosure addresses certain limitations in current ranging techniques that require two communicating devices to be in close relative proximity. In the embodiments of FIGS. 1A and 1B, however, there is a need to communicate with devices located out of range of the initiating device. Extended ranging operations using the multi-hop strategy discussed herein are therefore performed to trigger a requested service or activity of a target device with reduced latency. When the number and/or density of such devices is relatively high, as in the exemplary networked ecosystem 10A of FIG. 1B, identifying suitable intermediate nodes between the initiator node 201 and the target node 20T may be achieved using the present centralized strategy to identify suitable ranging paths between nodes. Furthermore, when nodes that require ranging information do not collectively reside within a given communication network, e.g., in Area #1 or Area #2 of FIG. 3, and thus require communication with an intermediate node such as the central controller 20 of FIG. 4A, the present strategy enables orchestration of the extended range. In a proprietary network application as noted above, a designated node may be used as a proxy node to initiate a proximity ranging session. The commissioning process may include authorizing a use of the initiator node 201 or the target node 20T during the proximity ranging session. These and other attendant benefits will be readily appreciated by those possessing ordinary skill in the art in view of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A centralized proximity ranging method for use in a networked ecosystem, the networked ecosystem having an initiator node located in an initiator network, a plurality of relay nodes including a designated node, and a target node located in a target network and out of range of the initiator node, the centralized proximity ranging method comprising:
accessing a recorded activation profile in a computer readable storage medium as a desired action or service of the target node;
identifying a ranging path between the initiator node and target node, including communicating ranging parameters between the initiator network and the target network, wherein the ranging path includes the designated node; and
requesting performance of the desired action or service over the ranging path, wherein the designated node is a smart node located in the initiator network of the initiator node or the target network of the target node.

2. The method of claim 1, wherein identifying the ranging path includes estimating, via a central controller using a proximity ranging protocol, respective proximity ranges to one or more neighboring nodes of the plurality of relay nodes within a range limit of the initiator node, respective nodes of the one or more neighboring nodes being in the initiator network of the initiator node or the target network of the target node.

3. The method of claim 2, wherein the central controller includes a cloud-based server, and wherein identifying the ranging path is performed using the cloud-based server.

4. The method of claim 2, further comprising:
dynamically determining an internodal distance between the initiator node and the target node based at least in part on the respective proximity ranges to the one or more neighboring nodes; and
requesting the desired action or service via the one or more neighboring nodes upon determining that the internodal distance between the initiator node and the target node is not greater than an activation threshold.

5. The method of claim 3, wherein determining the internodal distance between the initiator node and the target node is further based on estimating an angle-of-arrival of a signal exchanged between the initiator node and a neighboring node of the plurality of relay nodes, and estimating an angle-of-arrival of a signal exchanged between the target node and the neighboring node.

6. The method of claim 5, further comprising:
estimating a range to the neighboring node based on a time-of-arrival of a signal sent by the initiator node to the neighboring node.

7. The method of claim 6, further comprising:
upon the estimating the range to the neighboring node, instructing the neighboring node to estimate the range between itself and the target node.

8. The method of claim 1, wherein the designated node is configured with authentication, security, and/or privileges to interact with one or more of the relay nodes.

9. The method of claim 1, wherein the designated node is configured with authentication, security, and/or privileges to interact with the initiator node or the target node, and wherein the initiator node and/or the target node is not capable of or not allowed to directly interact with any other node on a network of which the designated node is a member.

10. The method of claim 1, further comprising:
establishing a communications link between the initiator network and the target network, via a central controller, using a plurality of wireless routers.

11. The method of claim 10, wherein accessing the recorded activation profile in the computer readable storage medium includes:
accessing the recorded activation profile in memory of the central controller; and
establishing communication links between the central controller, the initiator node, and the target node; and
communicating, via a wireless router, with: (a) the initiator node and a first set of the relay nodes, and (b) a second set of the relay nodes and the target node via a border router, wherein the plurality of wireless routers includes the wireless router and the border router.

12. The method of claim 1, further comprising measuring a time-of-arrival and an angle-of-arrival of a signal sent by the initiator node to one or more of the relay nodes, wherein the measuring the time-of-arrival and the angle-of-arrival of the signal is performed using the designated node, and wherein the designated node is an ultra-wideband (UWB)-capable node.

13. The method of claim 1, wherein the target network is a proprietary network, the method further comprising:
using the designated node as a proxy node to initiate a proximity ranging session during a commissioning process of the initiator node or the target node, wherein the commissioning process includes authorizing a use of the initiator node or the target node during the proximity ranging session.

14. The method of claim 1, further comprising:
using a shortest distance algorithm to determine a nodal path from the initiator node to the target node through one or more of the relay nodes.

15. The method of claim 1, further comprising:
periodically checking a status and connectivity of the one or more relay nodes at a sampling frequency; and
adjusting the sampling frequency based on a characteristic of the one or more relay nodes.

16. The method of claim 1, wherein:
the initiator node includes a smartphone or a vehicle, and the target node includes a smart home device; and
accessing the recorded activation profile includes accessing a recorded light, door, appliance, and/or vehicle charging station setting of the smart home device.

17. A networked ecosystem comprising:
a node operable for communicating ranging parameters between an initiator network and a target network;
a wireless router;
a border router;
an initiator node located in the initiator network;
a plurality of relay nodes, including at least one transit node and at least one smart node, the at least one smart node including a designated node;
a target node located in the target network, the target network being located outside of a range limit of the initiator node, wherein the node operable for communicating the ranging parameters is in communication with the initiator network and the target network via the wireless router and the border router, respectively; and
computer readable storage medium containing a recorded activation profile, the recorded activation profile including a desired action or service of the target node;
wherein the networked ecosystem is configured to:
use a centralized proximity ranging protocol to access the recorded activation profile;
identify a ranging path between the initiator node and the target node, the ranging path including the designated node; and
request performance of the desired action or service over the ranging path.

18. The networked ecosystem of claim 17, wherein the computer readable storage medium is part of a cloud-based server, and the initiator node or the least one smart node is configured as an ultra-wideband (UWB) node or a Wi-Fi capable node.

19. The networked ecosystem of claim 17, wherein the initiator network is in a first area or building, the target network is in a second area or building, the initiator node is part of a mobile device or sensor, and the target node is an automation robot operable for performing the desired action or service.

20. A networked ecosystem comprising:
an initiator node located in a first area as part of an initiator network, the initiator node having an ultra-wideband (UWB) capability;
a plurality of relay nodes, the plurality of relay nodes including at least one transit node and at least one smart node, wherein the at least one smart node includes the UWB capability, and wherein the at least one smart node includes a designated node;
a target node located in a second area as part of a target network, the target node being outside of a range limit of the initiator node and configured as an automation robot;
a computer readable storage medium containing a recorded activation profile, the recorded activation profile including a desired action or service of the target node;
a cloud-based central controller operable for communicating ranging parameters between the initiator network and the target network;
a first wireless router connecting the initiator network to the cloud-based central controller; and
a second wireless router connecting the target network to the cloud-based central controller, wherein the central controller is configured to use a centralized proximity ranging protocol to access the recorded activation profile, identify a ranging path between the initiator node and the target node, the ranging path including the designated node, and request performance of the desired action or service over the ranging path.
